(19) United States
(12) Patent Application Publication
(10) Pub. No.: US 2011/0008142 A1
(43) Pub. Date: Jan. 13, 2011

(54) Working Machine

(75) Inventor: Osamu GOKITA, Tsuchiura-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Construction Machinery Co., Ltd., Tokyo (JP)

(21) Appl. No.: 12/832,471

(22) Filed: Jul. 8, 2010

(30) Foreign Application Priority Data
Jul. 9, 2009 (JP) 2009-162999

(51) Int. Cl. E02F 9/14; F16C 11/04

(52) U.S. Cl. 414/722

(57) ABSTRACT

A working machine is provided with a front working mechanism. The front working mechanism includes a first working element, a second working element and a hydraulic cylinder. The hydraulic cylinder is connected at a forward end portion thereof to the second working element and at a rearward end portion thereof to the first working element, and is constructed pivotable relative to the second working element within a predetermined range of work angles. The working machine is provided with a pivotal movement restraining device for allowing the hydraulic cylinder to pivot within the predetermined range of work angles while the hydraulic cylinder is connected to the second working element but for restraining the hydraulic cylinder from pivoting beyond the predetermined range of work angles in a direction away from the first working element while the second working element is detached from the hydraulic cylinder.

### CROSS-REFERENCE TO RELATED APPLICATION

This application claims the priority of Japanese Patent Application 2009-162999 filed Jul. 9, 2009, which is incorporated herein by reference.

### BACKGROUND OF THE INVENTION

1. Field of the Invention

This invention relates to a working machine provided with a front working mechanism, which includes a working element and a hydraulic cylinder for operating the working element.

2. Description of the Related Art

A working machine such as a hydraulic excavator is generally equipped with a front working mechanism. This front working mechanism is provided with an arm (working element) connected for relative pivotal movement via a pin to a boom (working element) tiltably arranged on a revolving upperstructure, and also with a bucket (working attachment) connected for relative pivotal movement to the arm via a pin to perform digging work or the like. Further, hydraulic cylinders are also arranged to drive these working elements and working attachment, respectively.

In some instances, this front working mechanism may have to be detached partly or wholly for a restriction or the like on the transportation of the working machine. Because of a restriction, for example, under the Road Traffic Act, the working machine may not be transported in some instances unless its arm and bucket are detached. When the arm and bucket are detached from the boom, however, a forward end of an arm cylinder (hydraulic cylinder) is brought into an unheld state. When the boom is pivoted in such a state, a forward end portion of the arm cylinder moves out of control by the pivotal movement of the boom because the forward end of the arm cylinder is in the unheld state. As a result, an extreme stress is produced at a rearward end of the arm cylinder. This stress may cause damage on the arm cylinder and/or a hydraulic pipe connected to the arm cylinder. Especially when there is a need to pivot the boom from a lowered position to a raised position, the arm cylinder pivots in a direction away from the boom under an inertia force when the boom is stopped after its pivotal movement to the raised position. When the arm cylinder pivots beyond a certain range in the direction away from the boom, the extent of damage becomes very great including, for example, the formation of a crack in the arm cylinder and/or the hydraulic pipe connected to the arm cylinder.

To avoid such circumstances, a measure has heretofore been applied. According to this measure, an operator bundles a forward end portion (unheld portion) of a detached arm cylinder together with a boom by a band to fix the forward end portion on the boom. Such a measure is, however, accompanied by a problem that the operator's labor is needed. Moreover, if the operator forgets to wrap the band, damage on the arm cylinder and its hydraulic pipe cannot be prevented. In other words, with this conventional technology, the prevention of damage is left in the hands of the operator so that it has not adopted as a permanent measure.

Disclosed in JP-A-2007-100346 is a jig (supporting link structure) that holds a forward end portion of a bucket cylinder, said forward end portion having being brought into an unheld state after detachment of a bucket from an arm, on a forward end portion of the arm. According to this known technology, the forward end portion of the bucket cylinder can be held in place without free movements by simply fitting engaging portions of the jig in bores formed in the forward end portion of the arm after detachment of the bucket. Moreover, the forward end portion of the arm and the forward end portion of the bucket cylinder are allowed to undergo relative rotations to some extent. Even if the bucket cylinder is accidentally actuated, no excessive load is hence applied, thereby bringing about another merit that damage can also be prevented under such unforeseen circumstances.

### SUMMARY OF THE INVENTION

The above-described conventional technology, however, requires additional damage prevention work to surely hold the unheld portion immobile after the detachment of the working element. It, therefore, cannot be relied upon as a permanent measure for the prevention of damage insofar as there is a potential problem that an operator may forget this damage prevention work. In addition, the technology disclosed in JP-A-2007-100346 is accompanied by another problem in that its structure is complex and the jig for holding the unheld portion has to be manufactured at high cost.

With the foregoing current circumstances in view, the present invention has as an object thereof the provision of a working machine capable of permanently preventing damage on a hydraulic cylinder, which has been brought into an unheld state after detachment of a working element, and a hydraulic pipe connected to the hydraulic cylinder even without performing damage prevention work for the hydraulic cylinder. An other object of the present invention is to provide a working machine capable of preventing such damage at low cost.

To achieve these objects, the present invention provides in one aspect thereof a working machine provided with a front working mechanism, said front working mechanism including a first working element, a second working element arranged for relative pivotal movement on a side of an end of the first working element via a first connecting pin, and a hydraulic cylinder connected at a forward end portion thereof for relative pivotal movement to the second working element via a second connecting pin and connected at a rearward end portion thereof for relative pivotal movement to the first working element via a third connecting pin such that the second working element can be pivoted about the first connecting pin, and said hydraulic cylinder being constructed pivotable relative to the second working element about the third connecting pin within a predetermined range of work angles, wherein:

the working machine is provided with a pivotal movement restraining device for allowing the hydraulic cylinder to pivot within the predetermined range of work angles while the hydraulic cylinder is connected to the second working element but for restraining the hydraulic cylinder from pivoting about the third connecting pin beyond the predetermined range of work angles in a direction away from the first working element while the second working element is detached from the hydraulic cylinder.

According to the present invention constructed as described above, while the hydraulic cylinder is connected to the second working element, the hydraulic cylinder is allowed to pivot within the predetermined range of work angles so that work such as digging can be performed. Even when the second working element is detached from the hydraulic cylinder because of a requirement for transportation or the like, the hydraulic cylinder is prevented from freely pivoting out of control as the hydraulic cylinder is restrained from pivoting about the third connecting pin beyond the predetermined range of work angles in a direction away from the first working element. In other words, the range of pivotal movements of the hydraulic cylinder is limited by the pivotal movement restraining device in the present invention, and therefore, even when the second working element is detached from the hydraulic cylinder, the pivotal movement restraining device serves as a stopper for pivotal movements of the hydraulic cylinder, thereby making it possible to prevent damage on the hydraulic cylinder and/or the hydraulic pipe connected to the hydraulic cylinder.

In addition, the present invention does not require at all such conventional damage prevention work that, after the second working element is detached, an operator wraps the free end portion of the hydraulic cylinder together with the first working element by a band to fix the free end portion of the hydraulic cylinder. In other words, the present invention can prevent damage on the hydraulic cylinder and/or the like without needing additional damage prevention work after the detachment of the working element. As no work is required after the detachment, the present invention is also free of a potential risk that the hydraulic cylinder and/or the like may be damaged due to a failure to perform damage prevention work after the detachment. As appreciated from the foregoing, the present invention can permanently prevent damage on the hydraulic cylinder and the hydraulic pipe connected to the hydraulic cylinder.

It is to be noted that the expression “a predetermined range of work angles” as used herein means a range in which the hydraulic cylinder can undergo pivotal movements relative to the second working element about the third connecting pin.

In a preferred aspect, the pivotal movement restraining device may be composed of a single-piece member which is always fixedly held in place. In the present invention constructed so, the pivotal movement restraining device is composed of the single-piece member, and therefore, its structure can be simplified. It is, accordingly, possible to assure the prevention of damage at low cost.

In the above-described preferred aspect, the first working element may be provided with a pair of brackets on which the third connecting pin is supported at opposite ends thereof, the single-piece member may be a contact member with which the hydraulic cylinder comes into contact when the hydraulic cylinder pivots beyond the predetermined range of work angles in the direction away from the first connecting pin, and the contact member may be fixed on the paired brackets at a location forward of the third connecting pin and on a side of the forward end portion of the hydraulic cylinder. In the present invention constructed so, the single-piece member is the contact member fixed on the paired brackets, and therefore, its structure is very simple, thereby considerably contributing to a reduction in cost.

In the above-described preferred aspect, the single-piece member may be a contact member, which extends further rearward from the rearward end portion of the hydraulic cylinder and comes into contact with the first working element when the hydraulic cylinder pivots beyond the predetermined range of work angles in a direction away from the first working element. In the present invention constructed so, the single-piece member is the contact member extending further rearward from the rearward end portion of the hydraulic cylinder, and therefore, its structure is very simple, thereby considerably contributing to a reduction in cost.

According to the present invention, the pivotal movement restraining device enables relative pivotal movements of the second working element and hydraulic cylinder within the predetermined range of work angles, but after the detachment of the second working element, restrains the hydraulic cylinder from pivoting in the direction away from the first working element. The present invention, therefore, does not require at all such damage prevention work that after the detachment, the unheld forward end portion of the hydraulic cylinder is wrapped and fixed by a band. Because no additional damage prevention work is required, the working machine according to the present invention is free from a damage trouble which would otherwise be caused by a failure to perform damage prevention work after the detachment. The present invention, therefore, brings about an excellent advantageous effect that damage on the hydraulic cylinder and the hydraulic pipe or the like connected to the hydraulic cylinder can be permanently prevented. As the pivotal movement restraining device can be composed of a single-piece member, there is also a merit that damage on the hydraulic cylinder and the like can be prevented at low cost.

### BRIEF DESCRIPTION OF THE DRAWINGS

FIG. 1 is a side view illustrating a hydraulic excavator as a first embodiment of the working machine according to the present invention.

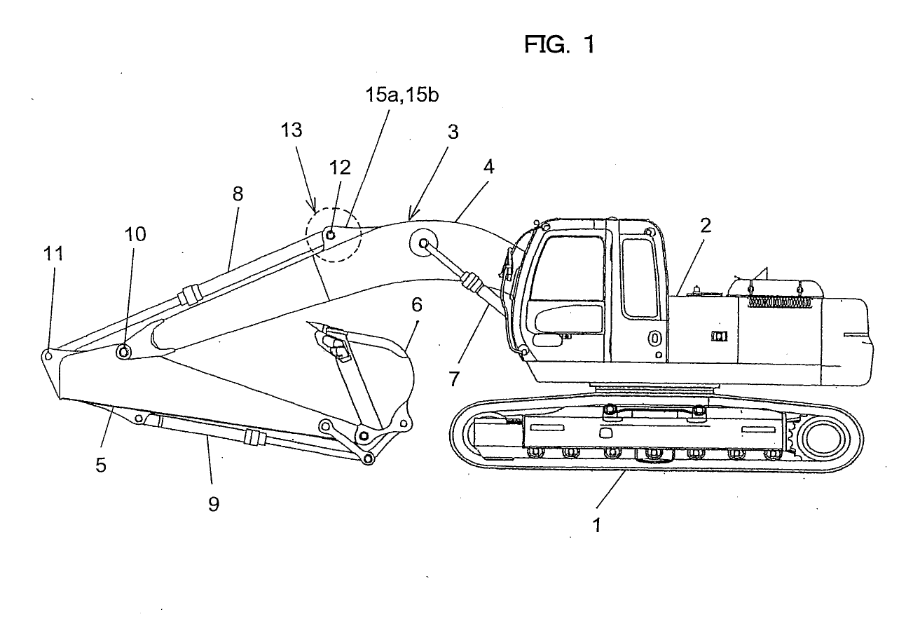

FIG. 2 is an enlarged fragmentary side view of the first embodiment illustrated in FIG. 1.

FIG. 3 is an external perspective view of a pivotal movement restraining device shown in FIG. 2.

FIG. 4 is an enlarged fragmentary side view of a second embodiment of the working machine according to the present invention.

### DETAILED DESCRIPTION OF PREFERRED EMBODIMENTS

The embodiments of the present invention will herein after be described with reference to the drawings. The hydraulic excavator as the first embodiment of the working machine according to the present invention is equipped with a travel base 1, a revolving upperstructure 2 mounted on the travel base 1, and a front working mechanism 3 mounted pivotally in an up-and-down direction on the revolving upperstructure 2 to permit digging work or the like. The front working mechanism 3 is provided with a boom (first working element) 4 pivotally attached to the revolving upperstructure 2, an arm (second working element) 5 attached for relative pivotal movement to a forward end of the boom 4 via a first connecting pin 10, a bucket 6 attached for relative pivotal movement to a forward end of the arm 5, a boom cylinder 7 for driving the boom 4, an arm cylinder 8 for driving the arm 5, and a bucket cylinder 9 for driving the bucket 6.

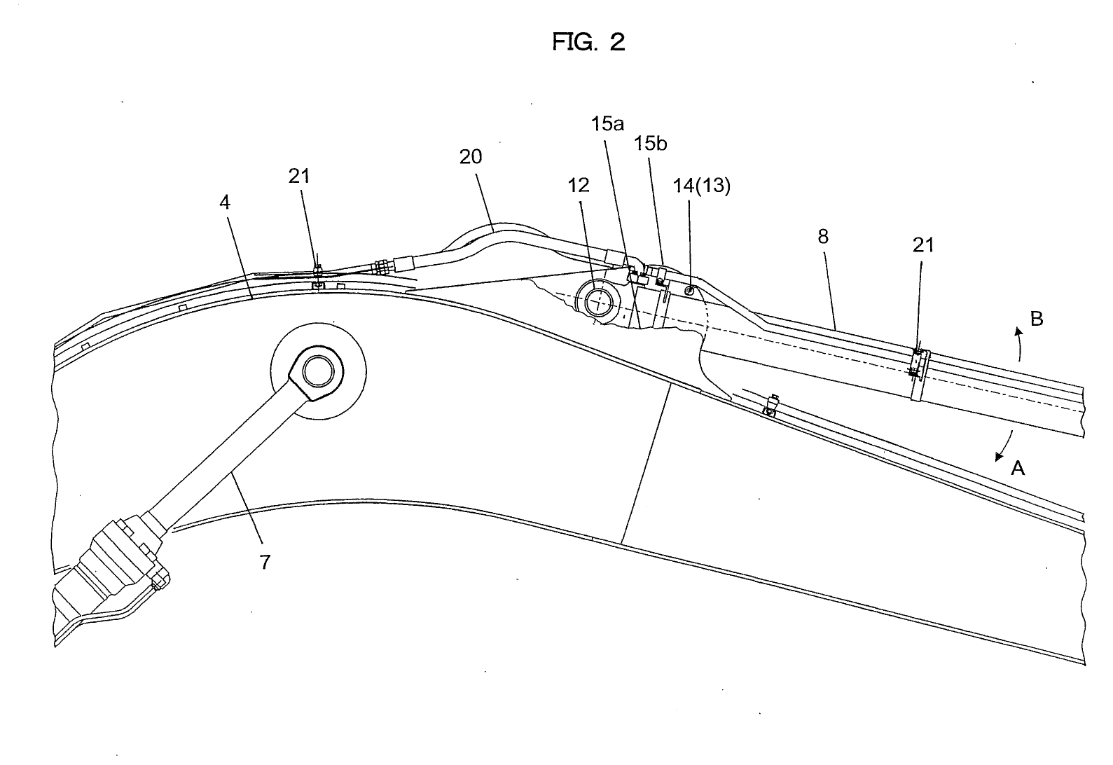

The arm cylinder 8 is connected at a forward end portion thereof for relative pivotal movement to the arm 5 via a second connecting pin 11, and is connected at a rearward end portion thereof for relative pivotal movement to the boom 4 via a third connecting pin 12. As a consequence, the arm 5 is pivoted about the first connecting pin 10 relative to the boom 4 when the arm cylinder 8 is actuated. As shown in FIG. 2, a hydraulic pipe 20 is connected to the arm cylinder 8 to feed working oil that is to be used for the actuation of the arm cylinder 8. This hydraulic pipe 20 is suitably fixed by supports 21 to protect it from damage under vibrations or the like.

As shown in FIG. 2, a pair of brackets 15a,15b are fixed on the boom 4 such that they face each other. On the paired brackets 15a, 15b, the third connecting pin 12 is fixed at opposite end portions thereof. The paired brackets 15a,15b, therefore, flank the arm cylinder 8 when the arm cylinder 8 is attached to the third connecting pin 12. It is to be noted that of the paired brackets shown in FIG. 2, the bracket 15a on the viewer's side is shown with a part thereof cut away for the sake of convenience of description.

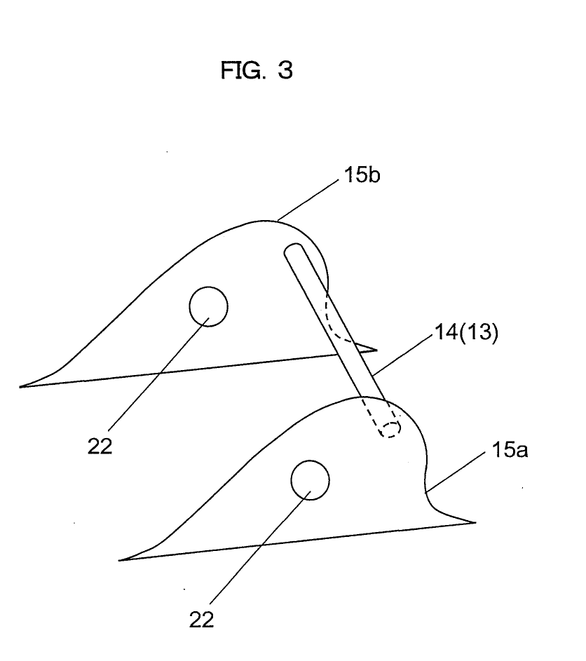

As depicted in FIG. 3, a bar (contact member) 14 is fixed as a pivotal movement restraining device 13 on the paired brackets 15a,15b. Described in further detail, the bar 14 is a single-piece member composed of a round bar of uniform diameter, and is fixedly secured at opposite ends thereof on the paired brackets 15a, 15b. This bar 14 is fixed on the paired brackets 15a, 15b at a location forward of locations of bores 22, in which the third connecting pin 12 is inserted, and on a side of the forward end portion of the arm cylinder 8 (in FIG. 2, at a location on a right side of the third connecting pin 12). As described above, the bar 14 is always fixed relative to the boom 4 via the brackets 15a,15b. Although not depicted in the figure, the bar 14 is wrapped with a protective sheet of soft material to protect the arm cylinder 8 from damage when the bar 14 comes into contact with the arm cylinder 8.

The height position at which the bar 14 is secured on the paired brackets 15a, 15b is set at a position that allows the following movement. Namely, the bar 14 is arranged at such a height position that it does not come into contact with the arm cylinder 8 even when the arm cylinder 8 pivots in a direction toward the boom 4 (in the direction of arrow A in FIG. 2) or in a direction away from the boom 4 (in a direction of arrow B in FIG. 2) about the third connecting pin 12 while the hydraulic excavator is performing work such as digging. According to the hydraulic excavator constructed as described above, the bar 14 allows the arm cylinder 8 to pivot in a predetermined range of work angles and does not interfere with work such as digging, and therefore, causes no inconvenience to the use of the hydraulic excavator.

When the arm 5 and bucket 6 are detached from the boom 4 to perform transportation or the like of the hydraulic excavator, on the other hand, the forward end portion of the arm cylinder 8 is brought into an upheld state, and therefore, the arm cylinder 8 pivots in the direction of arrow A or arrow B in FIG. 2 about the third connecting pin 12. Even when the arm cylinder 8 pivots in the direction of arrow B at this time, the bar 14 comes into contact with the arm cylinder 8 in this embodiment so that the pivotal movement of the arm cylinder 8 is restrained. In other words, the arm cylinder 8 is prevented by the bar 14 from pivoting in the direction of arrow B beyond the predetermined range of work angles so that the arm cylinder 8 and the hydraulic pipe 20 connected to the arm cylinder 8 are protected from damage. If the bar 14 were not arranged, the arm cylinder 8 would be allowed to pivot over about 180 degrees in the direction of arrow B (counterclockwise) about the third connecting pin 12 so that the arm cylinder 8 and the hydraulic pipe 20 would be unavoidably deformed or cracked and hence damaged significantly. According to the hydraulic excavator of this embodiment, such damage can be avoided.

Moreover, upon detachment of the arm 5 from the arm cylinder 8, this embodiment, owing to the arrangement of the bar 14, does not require such additional damage prevention work as wrapping the forward end portion of the arm cylinder 8 on the boom 4 with a band. This embodiment can, therefore, bring about an excellent advantageous effect that, even if such damage prevention work is forgotten after the detachment, the arm cylinder 8 and the hydraulic pipe 8 can be surely protected from damage. In addition, the obviation of such damage prevention work after the detachment does not require additional work either upon reassembling the arm 5. In other words, it is only necessary to connect the detached arm 5 to the arm cylinder 8.

As has been described above, this embodiment has made it possible to permanently prevent damage on the arm cylinder 8 and hydraulic pipe 20 by merely using a simple and economical, single-piece member, that is, the bar 14, and moreover, requires absolutely no additional damage prevention work for the prevention of damage.

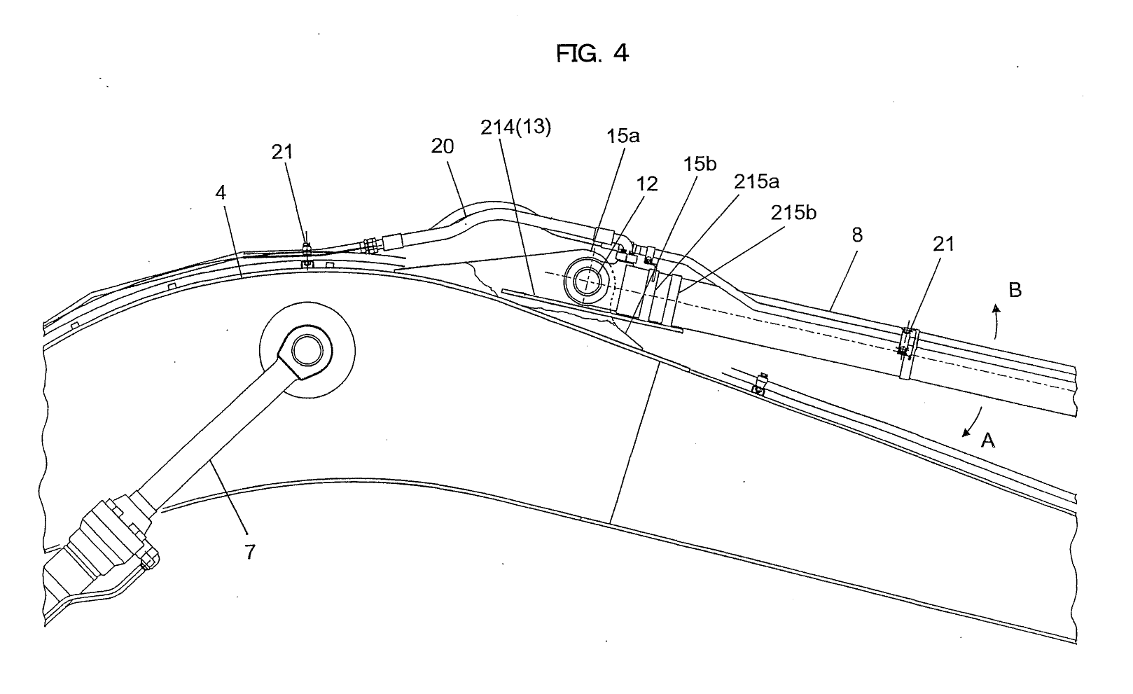

With reference to FIG. 4, a description will next be made about the second embodiment of the working machine according to the present invention. Like elements of construction as those in the above-described first embodiment will be identified by like reference numerals, and their description is omitted. A pivotal movement restraining device 13 in the second embodiment illustrated in FIG. 4 is a single-piece member, which is composed of a flat bar 214 extending rearward from the rear end portion of the arm cylinder 8 (in a leftward direction in FIG. 4). This flat bar 214 is an elongated plate-shaped member of uniform width, and is provided on a side of one end thereof with two rings 215, 215b for fixing it on the arm cylinder 8. By fitting these two rings 215,215b on the rearward end portion of the arm cylinder 8, the flat bat 214 is always fixedly secured on the arm cylinder 8.

The length of the flat bar 214 is set at a length that allows the following movement. Namely, the flat bar 214 has such a length that its rearward edge does not come into contact with the boom 4 even when the arm cylinder 8 pivots in a direction toward the boom 4 (in the direction of arrow A in FIG. 4) or in a direction away from the boom 4 (in a direction of arrow B in FIG. 4) about the third connecting pin 12 while the hydraulic excavator is performing work such as digging. In other words, the flat bar 214 is formed with such a length that the arm cylinder 8 does not hit the boom 4 within the range of work angles. According to the hydraulic excavator constructed as described above, the flat bar 214 allows the arm cylinder 8 to pivot in a predetermined range of work angles and does not interfere with work such as digging, and therefore, causes no inconvenience to the use of the hydraulic excavator.

When the arm 5 and bucket 6 are detached from the boom 4 to perform transportation or the like of the hydraulic excavator, on the other hand, the forward end portion of the arm cylinder 8 is brought into an unheld state, and therefore, the arm cylinder 8 pivots in the direction of arrow A or arrow B in FIG. 4 about the third connecting pin 12. Even when the arm cylinder 8 pivots in the direction of arrow B at this time, the flat bar 214 comes into contact with the boom 4 so that the pivotal movement of the arm cylinder 8 is restrained. In other words, the arm cylinder 8 is prevented by the flat bar 214 from pivoting in the direction of arrow B beyond the predetermined range of work angles so that the arm cylinder 8 and the hydraulic pipe 20 connected to the arm cylinder 8 are protected from damage. If the flat bar 214 were not arranged, the arm cylinder 8 would be allowed to pivot over about 180 degrees in the direction of arrow B (counterclockwise) about the third connecting pin 12 so that the arm cylinder 8 and the hydraulic pipe 20 would be unavoidably deformed or cracked and hence damaged significantly. According to the hydraulic excavator of this embodiment, such damage can be avoided.

Moreover, upon detachment of the arm 5 from the arm cylinder 8, this embodiment, owing to the arrangement of the flat bar 214, does not require such additional damage prevention work as wrapping the forward end portion of the arm cylinder 8 on the boom 4 with a band. This embodiment can, therefore, bring about an excellent advantageous effect that, even if such damage prevention work is forgotten after the detachment, the arm cylinder 8 and the hydraulic pipe 8 can be surely protected from damage. In addition, the obviation of such damage prevention work after the detachment does not require additional work either upon reassembling the arm 5. In other words, it is only necessary to connect the detached arm 5 to the arm cylinder 8.

As has been described above, this embodiment has also made it possible to permanently prevent damage on the arm cylinder 8 and hydraulic pipe 20 by merely using a simple and economical, single-piece member, that is, the flat bar 214, and moreover, requires absolutely no additional damage prevention work for the prevention of damage.

It is to be noted that as to each of the above-described embodiments, the description was made about the case in which the pivotal movement restraining device 13 was applied to the construction including the boom 4 as the first working element, the arm 5 as the second working element and the arm cylinder 8 as the hydraulic cylinder by way of example. Needless to say, the pivotal movement restraining device 13 can also be applied to another construction including the arm 5 as the first working element, the bucket 6 as the second working element and the bucket cylinder 9 as the hydraulic cylinder.

1. A working machine provided with a front working mechanism, said front working mechanism including a first working element, a second working element arranged for relative pivotal movement on a side of an end of the first working element via a first connecting pin, and a hydraulic cylinder connected at a forward end portion thereof for relative pivotal movement to the second working element via a second connecting pin and connected at a rearward end portion thereof for relative pivotal movement to the first working element via a third connecting pin such that the second working element can be pivoted about the first connecting pin, and said hydraulic cylinder being constructed pivotable relative to the second working element about the third connecting pin within a predetermined range of work angles, wherein:
the working machine is provided with a pivotal movement restraining device for allowing the hydraulic cylinder to pivot within the predetermined range of work angles while the hydraulic cylinder is connected to the second working element but for restraining the hydraulic cylinder from pivoting about the third connecting pin beyond the predetermined range of work angles in a direction away from the first working element while the second working element is detached from the hydraulic cylinder.

2. The working machine according to claim 1, wherein the pivotal movement restraining device is composed of a single-piece member which is always fixedly held in place.

3. The working machine according to claim 2, wherein the first working element is provided with a pair of brackets on which the third connecting pin is supported at opposite ends thereof, the single-piece member is a contact member with which the hydraulic cylinder comes into contact when the hydraulic cylinder pivots beyond the predetermined range of work angles in the direction away from the first connecting pin, and the contact member is fixed on the paired brackets at a location forward of the third connecting pin and on a side of the forward end portion of the hydraulic cylinder.

4. The working machine according to claim 2, wherein the single-piece member is a contact member, which extends further rearward from the rearward end portion of the hydraulic cylinder and comes into contact with the first working element when the hydraulic cylinder pivots beyond the predetermined range of work angles in a direction away from the first working element.
